(19) United States
(12) Patent Application Publication
(10) Pub. No.: US 2006/0252325 A1
(43) Pub. Date: Nov. 9, 2006

(54) Protection product

(76) Inventors: Mineaki Matsumura, Osaka-shi (JP); Shigeru Miyamoto, Ishikawa-gun (JP); Hideyuki Yamamoto, Kusatsu-shi (JP); Hirotaka Hananouchi, Otsu-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/530,273

(22) PCT Filed: Oct. 17, 2003
(86) PCT No.: PCT/JP03/13335

§ 371 Date: May 16, 2006

(30) Foreign Application Priority Data
Oct. 17, 2002 (JP) 2002-303119
Mar. 27, 2003 (JP) 2003-87786

(51) Int. Cl. F41H 1/02; B32B 27/04

(52) U.S. Cl. 442/123; 2/2.5

(57) ABSTRACT

A protection product made of (i) a woven fabric woven with a high-performance fiber, in which the opening rate of thread-opening treatment is 0 to 5%, and the width of a thread constituting the woven fabric is 10-fold or more relative to the thread thickness, (ii) a woven fabric in which the cross-sectional shape of a thread constituting the woven fabric is thinner on an edge side of both ends as compared with an intermediate part in the width direction, or (iii) a woven fabric woven with a twistless high-performance fiber having a fineness of 200 to 15,000 dtex, in which the ratio of the thread width to the thread thickness of at least one of a warp and a weft is 10 to 100, and the opening rate is 0 to 5%.

### TECHNICAL FIELD

The present invention relates to a flat woven fabric, its laminate, and a prepreg thereof and a fiber-reinforced plastic thereof. The present invention also relates to a protection product made using a composite molded product comprising the said materials.

### BACKGROUND ART

Previously, various protection products excellent in impact resistance to a projectile have been known. Such protection products contain, as a component material, for example, a metal, a laminate of a fabric such as a woven fabric and a non-woven fabric, a fiber-reinforced plastic, or a composite molded article comprising a ceramic or a metal and a fiber-reinforced plastic, and is used, for example, as a bullet-proof vest, a helmet, a shield, or a hard plate which is installed in a bullet-proof vest or a helmet (JP-A-72697/1997, JP-A-214796/1983, and JP-A-192497/1996). In particular, a protection product using a high-performance fiber excellent in impact resistance has high lightness and flexibility (in particular, bullet-proof vest) as compared with a protection product made of metal, but it is still heavy, and this is a great burden on users.

In recent years, powerful firearms such as a high-performance gun, rifle and the like have been developed. A projectile having high energy which is shot from such powerful firearms has a high penetrating force and, for this reason, it has become difficult to protect a human body, etc. against such projectiles using the aforementioned protection product.

In order to prevent penetration of the aforementioned projectile having high energy by use of a protection product, the number of layers of high-performance fiber woven fabrics used in a protection product is increased in some studies (JP-A-281697/1998 and JP-A-108594/1999). In such a case, however, there is a problem that a protection product becomes heavier and thicker, and, when the protection product is a bullet-proof vest, wearing property of the product is reduced. In addition, there is a problem that influence of the impact caused by the aforementioned projectile having high energy on a human body wearing a protection product, in particular, a bullet-proof vest or a helmet can not be neglected.

### DISCLOSURE OF THE INVENTION

A main object of the present invention is to provide a flat woven fabric which has an excellent impact resistance to a projectile and is light and its laminate; a fiber-reinforced plastic thereof, or a protection product made by use of a composite molded product using them.

In order to attain the aforementioned object, the present inventors intensively studied and, as a result, they have found that a protection product made using (i) a woven fabric woven with a high-performance fiber, wherein the opening rate due to thread-opening treatment is 0 to 5%, preferably 0 to 2%, and the width of a thread constituting the woven fabric is 10-fold or more (preferably 20-fold or more) relative to the thickness of a thread; (ii) a woven fabric woven with a high-performance fiber, wherein the cross-sectional shape of a thread constituting the woven fabric is thinner on an edge side of both ends as compared with an intermediate part in the width direction; or (iii) a woven fabric woven with a twistless high-performance fiber having a fineness of 200 to 15,000 dtex, wherein the ratio of the thread width to the thread thickness of at least one of the warp and the weft is 10 to 100, and the opening rate is 0 to 5%, is excellent in impact resistance to a projectile while it is light, and can solve the aforementioned problems at once.

After the present inventors obtained the above various findings, they studied further and, as a result, they completed the present invention.

That is, the present invention relates to:

1) a protection product characterized in that it is made using a woven fabric woven with a high-performance fiber, wherein the opening rate is 0 to 5% due to thread-opening treatment, and the width of a thread constituting the woven fabric is 10-fold or more relative to the thickness of the thread,

2) a protection product characterized in that it is made using a woven fabric woven with a high-performance fiber, wherein the opening rate is 0 to 2% due to thread-opening treatment, and the width of a thread constituting the woven fabric is 20-fold or more relative to the thickness of the thread,

3) a protection product characterized in that it is made using a woven fabric woven with a high-performance fiber, wherein the cross-sectional shape of a thread constituting the woven fabric is thinner on the edge side of both ends as compared with the intermediate part in the width direction,

4) a protection product characterized in that it is made using a woven fabric woven with a twistless high-performance fiber having a fineness of 200 to 15,000 dtex, wherein the ratio of the thread width to the thread thickness of at least one of a warp and a weft is 10 to 100, and the opening rate is 0 to 5%,

5) a protection product comprising a laminate in which woven fabrics according to the above 4) are laminated and fixed,

6) a protection product comprising a fiber-reinforced plastic containing a woven fabric woven with a twistless high-performance fiber having a fineness of 200 to 15,000 dtex, wherein the ratio of the thread width to the thread thickness of at least one of the warp and the weft is 10 to 100, and the opening rate is 0 to 5%, or a laminate in which the woven fabrics are laminated, a thermosetting resin and/or a thermoplastic resin,

7) a protection product comprising a composite molded product in which a metal or/and a ceramic is laminated on the fiber-reinforced plastic according to the above 6),

8) the protection product according to any one of the above 1) to 4) and 6), wherein the high-performance fiber is one or more fibers selected from aromatic polyamide, ultra high molecular weight polyethylene, polyparaphenylene benzobisoxazole,_polyether ether ketone, polyketone, liquid crystalline polyester, vinylon and polypyridobisimidazole,

9) the protection product according to any one of the above 1) to 7), which is a bullet-proof vest,

10) the protection product according to any one of the above 1) to 7), which is a helmet, and

11) the protection product according to any one of the above 1) to 7), which is a hard plate.

The fineness is a value measured according to JIS L1013. The thread width and the thread thickness are values obtained by embedding a woven fabric in a normal temperature curing-type epoxy resin, cutting out a cross-section of the embedded woven fabric, and measuring the length thereof with a microscope. The opening rate is a factor associated with a size of a gap part formed between weaving yarns and, when a region of an area S1 is provided on a woven fabric, and an area between gaps formed between weaving yarns in the area S1 is set to be S2, the opening rate is defined by the following equation:
Opening rate=(S2/S1)×100 (%)

By printing a woven fabric with a commercially available copying machine (e.g. trade name: Docu Centre 505 CP manufactured by Fuji Xerox Co., Ltd.), a gap part of the woven fabric looks white. Therefore, for convenient purposes, the opening rate is determined by obtaining an area (S2) of a white part, dividing the area by a whole area (S1), and multiplying this value by 100. In the present invention, the opening rate is usually about 0% to 5% (not less than 0% and not more than 5%), preferably about 0% to 3% (not less than 0% and not more than 3%), more preferably about 0% to 2% (not less than 0% and not more than 2%).

### BRIEF DESCRIPTION OF THE DRAWINGS

FIG. 1 is a perspective view showing a weaving machine having a thread-opening apparatus.

FIG. 2 shows a schematic construction of the thread-opening apparatus.

FIG. 3 shows main parts of a pressing device for use in the thread-opening apparatus, wherein FIG. 3A is a sectional view partly cut away, and FIG. 3B is a sectional view taken along line B-B of FIG. 3A.

### BEST MODE FOR CARRYING OUT THE INVENTION

The woven fabric (herein, also referred to as flat woven fabric) used in the present invention is not particularly limited as long as it is (i) a woven fabric woven with a high-performance fiber, wherein the opening rate due to thread-opening treatment is 0 to 5% (preferably 0 to 3%, more preferably 0 to 2%), and the thread width constituting the woven fabric is 10-fold or more (preferably 20-fold or more) relative to the thread thickness, (ii) a woven fabric woven with a high-performance fiber, wherein the cross-sectional shape of a thread constituting the woven fabric is thinner on an edge side of both ends as compared with an intermediate part in the width direction, or (iii) a woven fabric woven with a twistless high-performance fiber having a fineness of 200 to 15,000 dtex, wherein the ratio of a thread width and a thread thickness of at least one of the warp and the weft is 10 to 100, and the opening rate is 0 to 5%. According to the present invention, in the flat woven fabric, a cover factor (denoting a ratio of a thread occupying a woven fabric surface) calculated from the following weaving density (number of threads/2.54 cm) of a weft or a warp, and a fineness (dtex) is preferably about 500 to 1100, more preferably about 550 to 1050.
Cover factor=weft weaving density×(weft fineness)^{1/2}+warp weaving density×(warp fineness)^{1/2}

The high-performance fiber refers to a fiber excellent in some physical properties such as heat resistance, strength and elastic modulus. For example, regarding heat resistance, a fiber having flame retardant property of a limiting oxygen index of about 25 or more, and having heat resistance of a thermal decomposition temperature by a differential scanning calorimetry of about 400° C. or higher is preferable. Regarding the strength, a fiber having a tensile strength of about 17 cN/dtex or more is preferable, a fiber having a tensile strength of about 17 to 45 cN/dtex is more preferable, and a fiber having a tensile strength of about 19 to 40 cN/dtex is most preferable. In addition, regarding the elastic modulus, a fiber having an elastic modulus of about 300 to 2,000 cN/dtex is preferable, and a fiber having an elastic modulus of about 350 to 1,800 cN/dtex is more preferable. The limiting oxygen index is a value measured according to JIS K7201:1999 “Method of testing combustion of a high molecular material by oxygen index method”, and the thermal decomposition temperature is a value measured according to JIS K7120:1987 “Method of measuring thermogravimetry of plastics”. In addition, the tensile strength and the elastic modulus are values measured according to JIS L1013.

Examples of the high-performance fiber include one or more kinds of organic fibers selected from aromatic polyamide (aramid), aromatic polyether amide, wholly aromatic polyester, ultra high molecular weight polyethylene (UHMW-PE), polyparaphenylene benzobisoxazole, polyether ether ketone, polyketone, liquid crystalline polyester, vinylon (polyvinyl alcohol), polypyridobisimidazole, polytetrafluoroethylene, polyoxymethylene, polyacrylonitrile, polybenzimidazole, polyamide-imide (e.g. trade name: Kermel, manufactured by Rohne-Poulenc), polyimide, polyarylate, polyether ketone, polyetherimide, polyphenylene sulfide and Novoloid (Kynol) and others, and inorganic fibers such as a carbon fiber and a glass fiber and others. Inter alia, one or more kinds of fibers selected from aromatic polyamide, ultra high molecular weight polyethylene, polyparaphenylene benzobisoxazole, polyether ether ketone, liquid crystalline polyester, vinylon and polypyridobisimidazole are preferable.

As the aramid fiber, there are a meta-aramid fiber and a para-aramid fiber. Examples of the meta-aramid fiber include wholly meta-aromatic polyamide fiber such as polymetaphenyleneisophthalamide fiber (trade name: Nomex, manufactured by DuPont). Examples of the para-aramid fiber include all para-aromatic polyamide fiber such as polyparaphenylene terephthalamide fiber (trade name: Kevlar, manufactured by Toray Industries, Inc.•DuPont) and a copolyparaphenylene-3,4′-diphenyl ether terephthalamide fiber (trade name: Tecnola, manufactured by TEIJIN LIMITED).

The high-performance fiber may be a mixed fiber which is a combination of a fiber exemplified as a high-performance fiber as described above and other fiber (e.g. fiber such as aliphatic polyamide or aliphatic polyester). It is preferable that the high-performance fiber is a fiber having a fineness of about 200 to 15,000 dtex, and a twistless fiber is also preferable.

The high-performance fiber can be prepared by the known method such as wet spinning, liquid crystal spinning, gel spinning, virgin polymer spinning and gel press spinning. The high-performance fiber may be a commercial product, and examples of the commercial product include trade name TWARON (registered trademark) available from TEIJIN TWARON, trade name Kevlar (registered trademark) available from Toray Industries, Inc. •DuPont, trade name ZYLON (registered trademark) available from Toyobo Co., Ltd., trade name Dyneema (registered trademark) available from Toyobo Co., Ltd. and DMS, or trade name Spectra (registered trademark) available from Honeywell.

In the present invention, since productivity or property of a step of preparing a yarn or a step of processing yarn can be improved, the high-performance fiber may contain various additives. Examples of such various additives include a heat stabilizer, an antioxidant, an optical stabilizer, an ultraviolet-ray absorber, a smoothing agent, an antistatic agent, a releasing agent, a lubricant, a perfume, a plasticizer, a filler, a coloring agent, a thickener, an antibacterial and antifungal agent, a pigment and a flame retardant.

The flat woven fabric is prepared using a high-performance fiber. Examples of a process for preparing the flat woven fabric include a process of weaving the high-performance fiber, and performing thread opening treatment, more specifically, (i) a process for preparing the flat woven fabric by weaving the high-performance fiber, and flattening the resulting woven fabric with a roll under pressure, (ii) a process for preparing the flat woven fabric by weaving the high-performance fiber, and flattening the resulting woven fabric by high frequency vibration using water (e.g. degassed water, ion-exchange water, deionized water, electrolysis cationic or anionic water) as a medium, and (iii) a process for preparing the flat woven fabric by weaving a high-performance fiber, and flattening the resulting woven fabric by a water flowing pressure.

The method of weaving the flat woven fabric in (i), (ii) and (iii) may be any method as long as the high-performance fiber can be woven. Examples include a method of weaving the high-performance fiber using the known weaving machine, more specifically, a method of weaving the high-performance fiber using a jet weaving machine (e.g. air jet weaving machine or water jet weaving machine), a Sulzer weaving machine or a rapier weaving machine.

In the present invention, the process of (i) is preferable. In the process of (i), a nip pressure in a roll is usually about 1.5 to 20 MPa, preferably about 10 to 15 Pa, and the number of pressurization is usually about 1 to 60, preferably about 15 to 40.

The process of (i) will be explained more specifically below.

According to the present invention, it is preferable to use a weaving machine provided with a thread-opening apparatus in the process of (i).

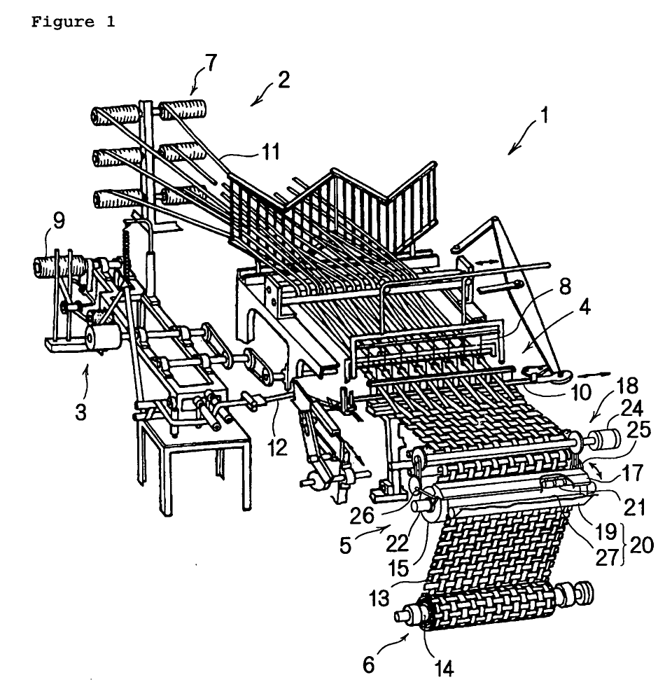

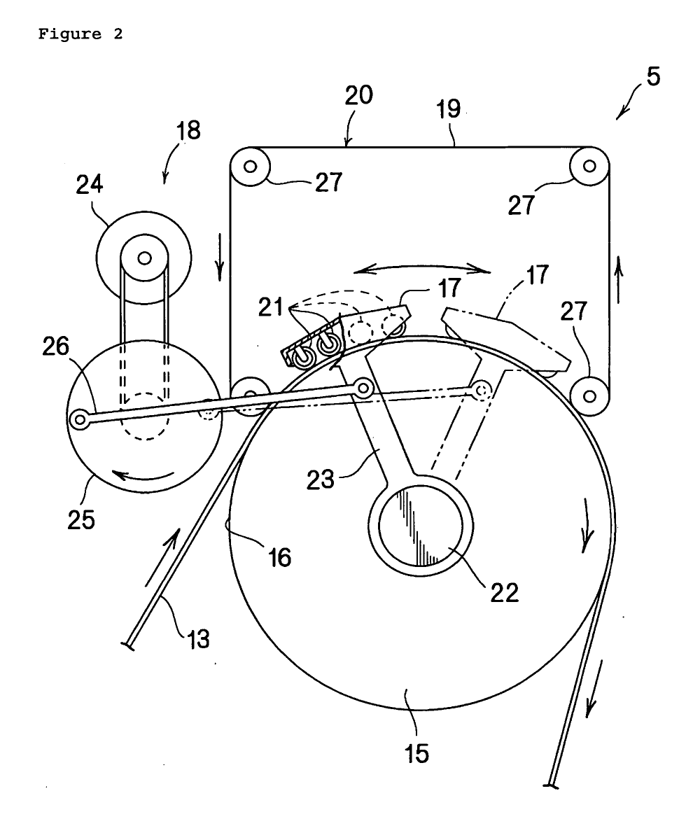

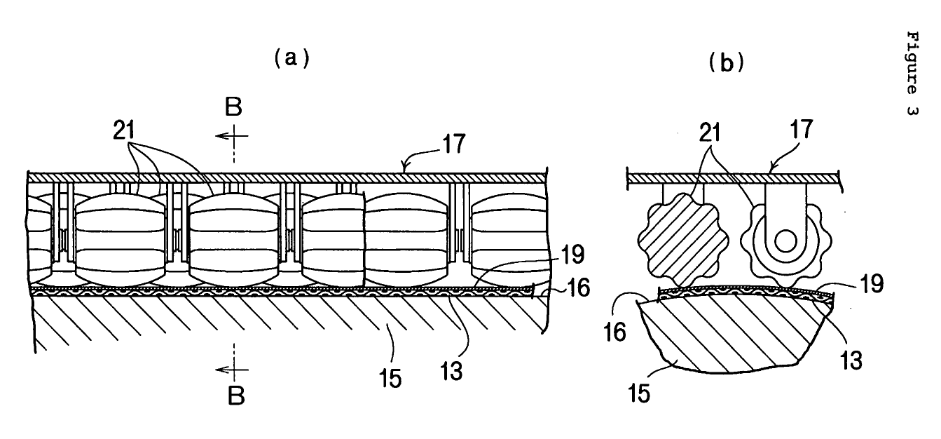

FIGS. 1 through 3 show a preferable embodiment of the present invention. FIG. 1 is a perspective view showing a weaving machine having a thread-opening apparatus. FIG. 2 shows a schematic construction of the thread-opening apparatus. FIG. 3 shows main parts of a pressing device for use in the thread-opening apparatus. FIG. 3A is a sectional view partly cut away. FIG. 3B is a sectional view taken along line B-B of FIG. 3A.

That is, when compared to the known weaving machines, the weaving machine shown in FIGS. 1 to 3 is characterized in that it is provided with a supporting means (15) for guiding a sheet-shaped woven fabric (13) towards a fixed direction while supporting the woven fabric, a press roll (21) which is arranged along a supporting surface (16) of this supporting means (15) and pressing the woven fabric (13) towards to the supporting means (15), and a reciprocation driving means (18) which moves this press roll (21) reciprocatory along the direction of guiding this woven fabric (13) while rolling the roll (21) on the woven fabric (13). By using such weaving apparatus, the sheet-shaped woven fabric (13) can be guided towards a fixed direction while supporting the woven fabric (13) on a supporting means (15), the woven fabric (13) can be pressed with a press roll (21) towards to the supporting means (15) and, at the same time, this press roll (21) can be moved reciprocatory along the direction of guiding the woven fabric (13) while rolling this press roll (21) on the woven fabric (13).

As shown in FIG. 1, a weaving machine 1 has a warp supply section 2, a weft supply section 3, a weaving section 4, a thread-opening apparatus 5, and a winding section 6.

Warps 11 pulled out of a creel 7 of the warp supply section 2 are supplied to a weaving section 4 through a heddle 8. On the other hand, wefts 12 pulled out of a bobbin 9 of the weft supply section 3 are inserted between the adjacent warps 11 by a rapier 10 in the weaving section 4 to weave the warps 11 and the wefts 12 into a sheet-shaped woven fabric 13. After the thread-opening apparatus 5 opens and flattens the warps 11 and the wefts 12 of the woven fabric 13, the woven fabric 13 is wound around a cross beam 14.

As shown in FIGS. 1 and 2, the thread-opening apparatus 5 includes a supporting roll 15 guiding the woven fabric 13 to the winding section 6, with the supporting roll 15 supporting the woven fabric 13, a pressing part 17 disposed along a supporting surface 16 of the supporting roll 15, a driving part 18 for reciprocating the pressing part 17 along the direction in which the woven fabric 13 is guided, and a protective sheet supply part 20 for supplying a protective sheet 19 to the gap between the pressing part 17 and the woven fabric 13.

The supporting roll 15 is disposed parallel to the surface of the woven fabric 13. The peripheral surface, namely, the supporting surface 16 of the supporting roll 15 is made of a hard material such as a hard rubber or a metallic material. The supporting roll 15 rotates at a low speed equal to the moving speed of the woven fabric 13.

The pressing part 17 has a plurality of rotatable pressure rolls 21 disposed parallel to the supporting surface 16. Each pressure roll 21 presses the woven fabric 13 supported by the supporting surface 16 toward the supporting surface 16. It is preferable to adjust the degree of the pressing force of the pressure roll 21 to suitably open the threads without adversely affecting the woven fabric 13. Thus each pressure roll 21 is provided with an unshown tool for adjusting the degree of its pressing force and a cushioning member.

As shown in FIG. 3A, the peripheral surface of the pressure roll 21 bulges in its central part like a hand drum. As shown in FIG. 3B, the peripheral surface of the pressure roll 21 is corrugated to cause the up and down movement in the circumferential direction.

The pressure rolls 21 each having a length of less than 20 mm are arranged in series in the width direction of the woven fabric 13 to press the entire woven fabric 13 uniformly. The pressure rolls 21 of adjacent rows shift from each other in the width direction of the woven fabric to allow the woven fabric 13 positioned between the adjacent pressure rolls 21 of each row to be pressed by the pressure roll 21 of the adjacent row.

As shown in FIGS. 1 and 2, the pressing part 17 has a pivoting arm 23 pivoting on a rotation shaft 22 of the supporting roll 15. The driving part 18 for reciprocating the pressing part 17 includes a driving motor 24, a rotary disk 25 to be driven by the driving motor 24, and a connection rod 26. The connection rod 26 interlocks the rotary disk 25 with the pivoting arm 23. Thereby, when the rotary disk 25 rotates, the pivoting arm 23 pivots on the rotation shaft 22 of the supporting roll 15. As a result, the pressure rolls 21 reciprocate along the direction in which the woven fabric 13 is guided.

The protective sheet supply part 20 has a plurality of guide rolls 27 for circulating the protective sheet 19. While the protective sheet 19 is circulating along the periphery of each guide roll 27, the protective sheet 19 is supplied to the gap between the pressure rolls 21 and the woven fabric 13.

The protective sheet 19 is not indispensable for the present invention. The protective sheet 19 is used when there is a possibility that the frictional force generated between the pressure rolls 21 and the woven fabric 13 affects the woven fabric 13 adversely. Therefore the protective sheet 19 can be composed of any materials capable of transmitting the pressing force of the pressure rolls 21 to the woven fabric 13 and reducing the frictional force of the pressure roll 21. For example, as the protective sheet 19, it is possible to use a film of synthetic resin such as polypropylene having a thickness in the range of several tens of micrometers to 0.2 millimeters.

The operation of flattening the woven fabric using the thread-opening apparatus is described below.

After the threads are woven into the fabric 13 in the weaving section 4, the woven fabric 13 is fed along the periphery of the supporting roll 15 of the thread-opening apparatus 5 and then guided to the winding section 6, while the woven fabric 13 is being supported by the supporting surface 16. After the protective sheet 19 is supplied to the upper surface of the woven fabric 13 supported by the supporting surface 16, the pressure rolls 21 of the pressing part 17 press the woven fabric 13 through the protective sheet 19. Owing to the operation of the driving part 18 for reciprocating the pressing part 17, the pressing part 17 including pressure rolls 21 reciprocates along the direction in which the woven fabric 13 is guided. The moving speed of the pressing part 17 is much higher than that of the woven fabric 13. The pressure rolls 21 move while they are rolling over the woven fabric 13 through the protective sheet 19. Thereby the woven fabric 13 is pressed collectively in the vicinity of the portions of contact between the protective sheet 19 and each of the pressure rolls 21. Since the woven fabric 13 is pressed repeatedly by the reciprocating movement of the pressing part 17, the warps 11 and the wefts 12 constituting the woven fabric 13 are preferably opened. When the protective sheet 19 passes the pressing part 17, the protective sheet 19 separates from the woven fabric 13 and circulates along the periphery of the guide rolls 27, while the sheet-shaped woven fabric 13 is guided to the winding section 6.

In the case where warps and wefts consisting of aramid fibers of 3300 dtex are woven into the fabric by the weaving machine and opened by the thread-opening apparatus, the width of each thread was 3.64 mm, and the thickness thereof was 0.118 mm. Thus, the width of the thread is a little over 30 times as large as the thickness thereof, and the opening rate is 0.5%.

The aramid fiber is used as the warp and the weft in the embodiment. However, the warp or the weft may consist of high-performance fibers such as a carbon fiber other than the aramid fiber. In addition, the warp or the weft may consist of the high-performance fiber, whereas the other may consist of a synthetic resin fiber.

In the embodiment, flat fibers may be opened after they are woven, or unflattened fibers may be opened and flattened after they are woven.

In the embodiment, the driving part for reciprocating the pressing part is constructed of the rotary disk and the connection rod. However, the driving part for reciprocating the pressing part may be constructed of other mechanisms such as a cam. Needless to say, the other constructive parts such as the pressing part and the supporting means and the like and the weaving machine are not limited to the one of the embodiment respectively.

In the embodiment, the thread-opening apparatus is preferable because it is disposed between the weaving section of the weaving machine and the winding section thereof to allow the weaving processing and the thread-opening processing to be successively performed. However, the thread-opening apparatus may be disposed separately from the weaving machine.

When the sheet-shaped woven fabric is pressed by the pressure roll over the supporting means, the pressing force of the pressure roll concentrates on the neighborhood of the portion of contact between the protective sheet (woven fabric) and the pressure roll. Thus the pressed fibers are capable of moving easily. Further, the woven fabric is pressed at a plurality of times by the reciprocating movement of the pressure roll. Therefore, the threads composing the woven fabric are opened accurately and preferably in the width direction thereof irrespective of the direction in which the threads are disposed. Because the pressure roll rolls over the woven fabric, a small frictional force is generated between the pressure roll and the woven fabric. Thus it is possible to prevent the deviation of each thread to the width direction thereof in the thread-opening processing and restrain generation of a nonuniform weave pattern. As a result, in the woven fabric after thread-opening, for example, the opening rate is 0 to 5%, preferably 0 to 3%, more preferably 0 to 2%, and the width of a thread constituting the woven fabric becomes 10 to 100-fold, preferably 20-fold or more, more preferably 25-fold more, further preferably 30-fold or more relative to the thickness of a thread.

The number of the pressure rolls and the reciprocating speed thereof are not limited specifically. However, each thread can be pressed at a higher number of times by increasing the number of the pressure rolls and the reciprocating speed thereof, thereby opening the threads to a higher extent.

The pressure roll applies a high pressing force to thick portions of the woven fabric, whereas the pressure roll applies a low pressing force to flattened thin portions thereof. For example, at the intersection of a warp and a weft, adjacent warps are disposed on and under the weft or adjacent wefts are disposed on and under the warp. Thus the woven fabric is thick at the end of each thread in its width direction. The thick portion is preferably pressed and flattened. Consequently each thread becomes flattened and thinner gradually from the central portion to the edge side of both ends in the sectional configuration like a convex lens. Owing to the rolling movement of the pressure roll, the pressing force of the pressure roll is applied linearly or in a dotted manner to fibers constituting each of the threads. The pressing force is eliminated from the fibers immediately after the pressure roll passes them. The pressing force is applied to the thick portion of the woven fabric. When the fibers move and become flat, the degree of the pressing force becomes low. Consequently, the pressing force is prevented from being excessively applied to the fibers.

A laminate used in the present invention is prepared using the flat woven fabric mentioned above. Examples of such process include a process for preparing the laminate by laminating and fixing the flat woven fabric, more specifically, a process for preparing the laminate by piling at least two of the flat woven fabrics, and fixing the at least two laminated flat woven fabrics. Examples of the fixing method include a sewing method and an adhering method, more specifically, a method of sewing the at least two laminated flat woven fabrics by the known sewing method such as quilting and stitching, and a method of fixing the piled flat woven fabrics by adhering the at least two laminated flat woven fabrics with an adhesive, and drying this. As the adhesive, any adhesive can be used as long as it can adhere to the flat woven fabric. The adhesive may be the known one. Examples thereof include an epoxy-based adhesive, a urethane-based adhesive, an emulsion-based adhesive, a synthetic rubber-based adhesive, an elastic adhesive, an instant adhesive and a structural adhesive. In the present invention, the flat woven fabric may be cut before lamination of the flat woven fabric, or the flat woven fabric may be cut after lamination. When the flat woven fabric is cut, a cutting method may be the known one, and examples of such method include a method using a cutter, and a punching method.

According to the present invention, a prepreg can be prepared from the flat woven fabric or the laminate and a thermosetting resin or/and a thermoplastic resin. The prepreg contains a composite with a thermoplastic resin in addition to the flat woven fabric and the laminate and a thermosetting resin.

The thermosetting resin used in the prepreg may be any resin as long as it has thermosetting property. Examples thereof include a phenol resin, an epoxy resin, an epoxy acrylate resin, a polyester resin (e.g. unsaturated polyester resin), a polyurethane resin, a diallyl phthalate resin, a silicone resin, a vinyl ester resin, a melamine resin, a polyamide resin, a polyimide resin, a polybismaleimide-triazine resin (BT resin), a cyanate resin (e.g. cyanate ester resin), a silicone resin, a polyphenylene ether resin (PPE resin), a polyethersulfone resin (PES resin), a polyether ether ketone resin (PEEK resin), a CP resin, a copolymer resin thereof, a modified resin obtained by modifying these resins, and a mixture thereof. The thermosetting resin can be prepared by the known method such as successive polymerization (e.g. polycondensation or polyaddition) and chain polymerization (addition polymerization or ring-opening polymerization). The thermosetting resin may be a commercial product, and examples of the commercial product include trade name: Sumilite resin (registered trademark) available from Sumitomo Bakelite Co., Ltd., and trade name acme light available from the Nihon Gosei Kako Co., Ltd.

In the present invention, it is preferable that the thermosetting resin is a phenol resin, an unsaturated polyester resin or vinyl ester. In the present invention, a ratio of the thermosetting resin to be incorporated is preferably about 3 to 30% by mass, more preferably about 5 to 20% by mass relative to a total prepreg.

As the thermoplastic resin used in the prepreg, any resin may be used as long as it is a resin having thermoplasticity. Examples include a polyester resin such as a polyethylene terephthalate resin (PET resin), a polybutylene terephthalate resin (PBT resin), a polytrimethylene terephthalate resin (PTT resin), a polyethylene naphthalate resin (PEN resin), and a liquid crystalline polyester resin; a polyolefin-based resin such as a polyethylene resin, (PE resin), a polypropylene resin (PP resin), and a polybutylene resin; a styrene-based resin; a polyoxymethylene resin (POM resin); a polyamide resin (PA resin); a polycarbonate resin (PC resin); a polymethylene methacrylate resin (PMMA resin); a polyvinyl chloride resin (PVC resin); a polyphenylene sulfide resin (PPS resin); a polyphenylene ether resin (PPE resin); a polyphenylene oxide resin (PPO resin); a polyimide resin (PI resin); a polyamide-imide resin (PAI resin); a polyether imide resin (PEI resin); a polysulfone resin (PSU resin); a polyethersulfone resin; a polyketone resin (PK resin); a polyether ketone resin (PEK resin); a polyether ether ketone resin (PEEK resin); a polyarylate resin (PAR resin); a polyether nitrile resin (PEN resin); a phenol resin (e.g. novolac-type phenol resin, etc.); a phenoxy resin; a fluorine resin; a polystyrene-based, polyolefin-based, polyurethane-based, polyester-based, polyamide-based, polybutadiene-based, polyisoprene-based or fluorine-based thermoplastic elastomer; and a copolymer resin or a modified resin thereof. These thermoplastic resins can be prepared by the known method such as the aforementioned polymerization. The thermoplastic resins may be a commercial product, and examples of such commercial product include trade name Tuftec (registered trademark), Tufprene (registered trademark) and Asaprene T (registered trademark available from Asahi Chemical Industry Co. Ltd.), a trade name QT compound, Thermorun, and SUNPRENE (registered trademark), SUNFROST (registered trademark) and MIRAPRENE available from Mitsubishi Chemical MKV Co. In the present invention, it is preferable that the thermoplastic resin is a polyolefin-based resin such as a polyethylene resin and a polypropylene resin, a thermoplastic elastomer, or a copolymer resin or a modified resin thereof. In the present invention, the ratio of the thermoplastic resin to be incorporated is preferably about 3 to 30% by mass, more preferably about 5 to 20% by mass relative to a total prepreg.

According to the present invention, “the thermosetting resin and thermoplastic resin” used in the prepreg include a composite resin of the thermosetting resin and the thermoplastic resin, and examples of such composite resin include an epoxy-polyethersulfone (PES) composite resin, an epoxy-polysulfone (PSU) composite resin, an epoxy-polyphenylene sulfide (PBS) composite resin and a polyvinyl butyral-modified phenol resin. The composite resin can be prepared, for example, by the known method such as the aforementioned polymerization.

In the present invention, the prepreg can be prepared by combining the flat woven fabric or the laminate and the thermosetting resin or/and the thermoplastic resin. Examples of such process include (a) a process for preparing the prepreg by immersing the flat woven fabric or the laminate in a solution or a dispersion of the thermosetting resin or/and the thermoplastic resin, coating a goal adhesion amount by the known method using a bar coater or clearance roll as necessary, and drying the coated product, (b) a process for preparing the prepreg by coating the flat woven fabric or the laminate with a solution or a dispersion of the thermosetting resin or/and the thermoplastic resin using spraying, coating, dipping, roller or brush, and drying the coated product, and (c) a process for preparing the prepreg by heating and melting the thermoplastic resin, impregnating the flat woven fabric with a melt, and cooling it.

The aforementioned solution or dispersion of the thermosetting resin or/and the thermoplastic resin is a solution or a dispersion in which the thermosetting resin or the thermoplastic resin is dissolved or dispersed, for example in a solvent and, as such solvent, any solvent may be used as long as it can dissolve or disperse the thermosetting resin or the thermoplastic resin. Examples of the solvents include acetone, methyl ethyl ketone, toluene, xylene, methyl isobutyl ketone, ethyl acetate, ethylene glycol monomethyl ether, N,N-dimethylformamide, N,N-dimethylacetamide, methanol, ethanol, methylcellosolve, methylpyrrolidone, chloroform and cyclohexanone.

The heating temperature in the process (c) is usually a temperature not lower than the melting point of the thermoplastic resin, preferably a temperature of about 5° C. higher than the melting point of the thermoplastic resin, more preferably a temperature of about 5 to 50° C. higher than the melting point of the thermoplastic resin. Cooling in the process (c) may be rapid cooling or gradual cooling. The cooling method may be the known method, and examples include a method using water, ice water, ice, dry ice or liquid nitrogen, and cooling in the air.

In the present invention, the aforementioned various additives may be contained in the prepreg.

In the present invention, when the thermosetting resin is used in the prepreg, the prepreg may contain a curing agent or a curing aid. The curing agent or the curing aid can be appropriately selected depending on the kind of the thermosetting resin. For example, when the thermosetting resin is an epoxy resin, examples of the curing agent include a polyamine-based curing agent, an acid anhydride-based curing agent, a tertiary amine compound-based curing agent, an imidazole compound-based curing agent, phenol novolak, trioxane trimethylene mercaptan, a compound having an isocyanate group, a compound having a phenol group, a compound having a hydrazide group, and a compound having a carboxyl group.

Examples of the above polyamine-based curing agent include compounds such as diethylenetriamine, triethylenetetramine, tetraethylenepentamine, diethylaminopropylamine, polyamidepolyamine, menthenediamine, isophoronediamine, N-aminoethylpiperazine, 3,9-bis(3-aminopropyl)-2,4,8,10-tetraoxaspiro(5,5)undecane adduct, bis(4-amino-3-methylcyclohexyl)methane, bis(4-aminocyclohexyl)methane, metaxylenediamine, diaminodiphenylmethane, diaminodiphenylsulfone, m-phenylenediamine, dicyandiamide, and adipic acid hydrazide.

Examples of the acid anhydride-based curing agent include compounds such as phthalic anhydride, tetrahydrophthalic anhydride, hexahydrophthalic anhydride, methyltetrahydrophthalic anhydride methylhexahydrophthalic anhydride, metylnadic anhydride, dodecylsuccinic anhydride, chlorendic anhydride, pyromellitic anhydride, benzophenonetetracarboxylic anhydride, ethylene glycol bis(anhydrotrimellitate), methylcyclohexenetetracarboxylic anhydride, trimellitic anhydride and polyazelaic anhydride.

Examples of the tertiary amine compound-based curing agent include compounds such as benzyldimethylamine, 2-(dimethylaminomethyl)phenol, 2,4,6-tri(diaminomethyl)phenol, and tri-2-ethylhexylic acid salt of 2,4,6-tri(diaminomethyl)phenol.

Examples of the imidazole compound-based curing agent include compounds such as 2-methylimidazole, 2-ethyl-4-methylimidazole, 2-undecylimidazole, 2-heptadecylimidazole, 2-phenylimidazole, 1-benzyl-2-methylimidazole and 1-cyanoethyl-2-methylimidazole.

When the thermosetting resin is an epoxy acrylate resin, an unsaturated polyester resin or avinyl ester resin, the curing agent include, for example, a peroxide such as benzoyl peroxide, parachlorobenzoyl peroxide, 2,4-dichlorobenzoylperoxide, capryl peroxide, lauroyl peroxide, acetyl peroxide, methyl ethyl ketone peroxide, cyclohexanone peroxide, bis(l-hydroxycyclohexyl peroxide), hydroxyheptyl peroxide, t-butyl hydroperoxide, p-menthane hydroperoxide, cumene hydroperoxide, 2,5-dimethylhexyl-2,5-dihydroperoxide, di(t-butyl peroxide), dicumyl peroxide, 2,5-dimethyl-2,5-di(t-butylperoxy)hexane, 2,5-dimethylhexyl-2,5-di(peroxybenzoate), t-butyl perbenzoate, t-butyl peracetate, t-butyl peroctoate, t-butyl peroxyisobutylate, di(t-butyl)di(perphthalate), and persuccinic acid.

When the thermosetting resin is a polyurethane resin, the curing agent include, for example, compounds having an isocyanate group, more specifically, such as tolylene diisocyante, polymethylene polyphenyl polyisocyanate, 4,4-diphenylmethane diisocyanate, 1,5-naphthalene diisocyanate, triphenylmethane triisocyanate, tolidine diisocyanate, xylene diisocyanate, hexamethylene diisocyanate, norbornene diisocyanate, dicyclohexylmethane diisocyanate and isophorone diisocyanate.

Examples of the curing aid include compounds having a hydroxy group, more specifically, such as water, alcohols (e.g. methanol, ethanol, n-propanol, n-decanol, isopropyl alcohol, sec-butyl alcohol, tert-butyl alcohol, ethylene glycol, glycerin, etc.) and phenols (e.g. phenol (o-, m-, p-) cresol, (o-, m-, p-) ethylphenol, catechol, resorcinol, hydroquinone, etc.).

The ratio of the curing agent and the curing aid to be incorporated can be appropriately set depending on the kind of the resin.

The prepreg may contain other fiber product in addition to the flat woven fabric. Examples of such fiber products include thread, chopped strand, chopped strand mat, short fiber, glass powder, distance-fabric, braid, woven fabric, knitted fabric and non-woven fabric.

The fiber-reinforced plastic used in the present invention can be prepared from the flat woven fabric, the laminate or the prepreg, or a laminate of the prepregs. The fiber-reinforced plastic is prepared by combining the flat woven fabric, the laminate or the prepreg, or a laminate thereof with a resin, but in the prepreg or a laminate thereof which already contains a resin, resin treatment is not necessarily required. The laminate of the prepregs may be any laminate as long as at least two of the prepregs are laminated. The upper limit of the number of the laminates is not critical, but is usually about 1,000. The laminated layers maybe fixed, or may not be fixed. According to the present invention, the fiber-reinforced plastic contains the prepreg. In the present invention, it is preferable that the prepregs are cut into a desired size before lamination. Examples of a cutting method include a cutter and punching. The resin may be any resin as long as it is a resin which can be combined with the flat woven fabric, the laminate, the prepreg, or a laminate of the prepregs. The resin may be a natural resin, or a synthetic resin. Examples thereof include the aforementioned thermosetting resin or/and the thermoplastic resin. In addition, according to the present invention, when the prepreg or a laminate of the prepregs is used in the fiber-reinforced plastic, a thermosetting resin or/and a thermoplastic resin of the prepreg or the laminate of the prepregs may be called as the resin.

For example, when the resin is a thermosetting resin, examples of a process for preparing the fiber-reinforced plastic include a process using the known means such as heating and pressuring, more specifically, (i) a process for preparing the fiber-reinforced plastic by heating and pressurizing the flat woven fabric or the laminate, and a thermosetting resin to incorporate them, and (ii) a process for preparing the fiber-reinforced plastic by immersing the flat woven fabric, the laminate, the prepreg or the laminate of the prepregs in a solution or a dispersion of the thermosetting resin, and heating and pressurizing or/and drying the immersed product to incorporate them. Forming conditions in the above processes can be appropriately set depending on the kind of a resin. The solution or dispersion of a thermosetting resin in the (ii) may be the same solution or dispersion as that of a thermosetting resin used in preparing the prepreg. The above drying may be drying using the known drying means, and examples of such drying means include a drying means using natural drying or a drier.

When the resin is the aforementioned thermoplastic resin, examples of a process for preparing the fiber-reinforced plastic include (i) a process for preparing the fiber-reinforced plastic by applying a melt obtained by heating to melt the thermoplastic resin or a solution obtained by dissolving the thermoplastic resin to the flat woven fabric, the laminate, the prepreg or the laminate of the prepregs by the known coating method such as knife coating, gravure coating, slit die coating, screen coating, curtain coating or powder coating, and then drying the coated product, and (ii) a process for preparing the fiber-reinforced plastic by immersing the flat woven fabric, the laminate, the prepreg, or the laminate of the prepregs in a melt obtained by heating to melt the thermoplastic resin or a solution obtained by dissolving the thermoplastic resin, and drying the immersed product.

Examples of the method of heating and melting the thermoplastic resin in (i) and (ii) include a method of heating the thermoplastic resin to a melting point or higher to melt it, and examples of the dissolving method include a method of dissolving the thermoplastic resin using a solvent (e.g. hexane, methyl ethyl ketone, hexafluoroisopropanol, acetone, methyl ethyl ketone, toluene, xylene, methyl isobutyl ketone, ethyl acetate, ethylene glycol monomethyl ether, N,N-dimethylformamide, N,N-dimethylacetamide, methanol, ethanol, methylcellosolve, methylpyrrolidone, chloroform, cyclohexanone, toluene, xylene, etc.).

The above drying may be the same drying as that described above.

In the present invention, the amount of the thermoplastic resin adhered to the fiber-reinforced plastic is preferably about 3 to 30% by mass, more preferably about 5 to 20% by mass.

In the present invention, it is preferable that the fiber-reinforced plastic is prepared using the prepreg and the resin described above.

In addition, in the present invention, when the prepreg or the laminate of the prepregs is used in the fiber-reinforced plastic, and (i) a thermosetting resin or (ii) a thermoplastic resin of the prepreg or the laminate of the prepreg is used as the above (b) resin, examples of a process for preparing the fiber-reinforced plastic in (i) include a method of molding under heating and pressuring, and a hand lay-up method. Examples of a process for preparing the fiber-reinforced plastic in (ii) include a method of laminating a prepreg, and molding it under heating and pressurizing, and a method of holding a film between the flat woven fabrics or the laminates, and molding it under heating and pressurizing. Examples of the film include a film of the thermoplastic resin, and a semi-cured film of the thermosetting resin.

The composite molded product used in the present invention is prepared from the fiber-reinforced plastic and a metal or/and a ceramic. According to the present invention, the prepreg may be used as the fiber-reinforced plastic.

The ceramic used in the composite molded product may be the known ceramic. Examples of such ceramics include fine ceramics, more specifically, aluminas; nitrides; silica stones; borons; magnesias; a calcined mixture thereof; a composite of these and a metal; and a composite of these and a fiber. In the present invention, aluminas, nitrides and silica stones are preferable. According to the present invention, as the ceramic, only one kind of them may be used, or two or more kinds may be used in combination. In the ceramic, a compression strength of about 1,500 MPa or higher is preferable, a bending strength of about 300 MPa or higher is preferable, and a Vickers hardness of about 1,000 kg/mm² or higher is also preferable. According to the present invention, the compression strength is a value measured according to JIS R 1608, the bending strength is a value measured according to JIS R 1601, and the Vickers strength is a value measured according to JIS R 1610. In the present invention, when the ceramic is alumina, the purity of alumina is preferably about 85% or higher, more preferably about 95 to 99.9%. When the purity is 85% or higher, an amount of alumina to be added to the composite molded product is large, and energy absorbing performance at impact of the composite molded product against a projectile can become more excellent.

The metal used in the composite molded product may be the known one. Examples of such metal include a pure metal such as iron, aluminum, magnesium, titanium, nickel, zinc, lead and tin; an alloy of at least two or more kinds of metals; and an alloy of a nonmetal and a metal such as carbon steel, high tensile strength steel, chromium steel, chromium molybdenum steel, nickel chromium steel, nickel chromium molybdenum steel, ducol steel, Hadfield steel, ultrahigh strength steel, stainless steel, cast iron, copper alloy (e.g. brass, tin bronze, aluminum bronze or beryllium copper, etc.), aluminum alloy (e.g. Al—Cu alloy, Cu alloy, Al—Si alloy, Al—Mg alloy, duralumin, etc.), magnesium alloy (e.g. Mg—Al—Zn alloy, Mg—Zn—Zr alloy, Mg—rare earth element alloy, Mg—Th alloy, Mg—Mn alloy, Mg—Th—Mn alloy or Mg—Zn—R.E. alloy, etc.), titanium alloy, nickel alloy (e.g. Ni—Mn alloy, Ni—Cu alloy, Ni—Mo alloy, Ni—Cr alloy, etc.), zinc alloy, lead alloy and tin alloy. Among them, titanium, stainless steel, duralumin and titanium alloy are preferable, because they are excellent in lightness, hardness, durability and impact resistance. As the metal, these may be used alone, or a plurality of them may be used in combination. Examples of the nonmetal include organic compounds (e.g. the aforementioned resin, etc.) and inorganic compounds other than a metal (e.g. glass, nitrogen compound, sulfur compound, silicon compound, etc.).

The composite molded product can be prepared by laminating and incorporating the prepreg or the fiber-reinforced plastic and the ceramic or/and the metal. Examples of a method of incorporating the ceramic or/and the metal, and the fiber-reinforced plastic include (i) a process for preparing the composite molded product by adhering the ceramic or/and the metal, and the prepreg or the fiber-reinforced plastic using an adhesive (e.g. epoxy binder or urethane binder), and drying the product, and (ii) a process for preparing the composite molded product by heating and pressurizing the prepreg or the fiber-reinforced plastic and the ceramic or/and the metal to incorporated them, and cooling the product. Drying in (i) may be the same drying as that described above. When the prepreg or the fiber-reinforced plastic contains a resin having a melting point, a heating temperature in the (ii) is usually a temperature of a melting point of the resin or higher, preferably a temperature of about 5 to 50° C. higher than a melting point of the resin, and a pressurizing pressure is usually about 1 to 20 MPa, preferably about 2 to 10 MPa per 1 cm².

A shape of the composite molded product may be any shape, and may be planer or bent-like. Examples of the bent-like include horseshoe-shape, L-shape, U-shape, spiral shape, planar shape, and polygon such as triangle, quadrilateral (e.g. square, rectangle, trapezoid, etc.), pentagon and hexagon, but the bent-like is not limited to these shapes, and may be such that the composite molded product is bent into various shapes, if desired. In the present invention, when a shape of the composite molded product is plate-like or bent plate-like, it is preferable that a thickness thereof is uniform from a viewpoint of a weight. In the composite molded product having such preferable shape, by arranging the ceramic or/and the metal in a zigzag fashion, for example, impact resistance to a projectile can be further improved.

The protection product of the present invention may be any one as long as the flat woven fabric, the laminate or the fiber-reinforced plastic is used. Examples include a bullet-proof vest (including a stab resistant body armor and a ballistic and stab resistant body armor), a helmet, a bullet-proof plate (e.g. a plate to be inserted into a shield or a blade proof vest, a plate installed in a helmet), vehicle armoring, warship and other vessels, or aircraft additional armoring. Among them, a bullet-proof vest, a helmet and a hard plate are preferable.

The protection product of the present invention is prepared using the flat woven fabric, the laminate, the fiber-reinforced plastic or the composite molded product according to the conventional method. For example, the bullet-proof vest can be prepared by sewing using the flat woven fabric or the laminate according to the conventional method. The helmet can be prepared by molding processing using the prepreg, the fiber-reinforced plastic or the composite molded product according to the conventional method. The hard plate can be prepared by molding using the fiber-reinforced plastic or the composite molded product according to the conventional method.

### EXAMPLE 1

Using a high-performance fiber (trade name Kevlar 29, 3300 dtex; manufactured by DuPont-Toray Co., Ltd.), weaving and thread-opening were performed with a weaving machine provided with the following thread-opening apparatus. A woven flat woven fabric (opening rate 0.8%, cover factor 1034, thread width/thread thickness 19) was cut into a size of 30 cm×30 cm, 27 of cut flat woven fabrics were laminated, and a corner part was sewn with a sewing machine to obtain a woven fabric laminate. Using this woven fabric laminate, a bullet-proof vest was obtained by the conventional method.

[Weaving Machine Provided With Thread-Opening Apparatus]

As shown in FIG. 1, a weaving machine 1 has a warp supply section 2, a weft supply section 3, a weaving section 4, a thread-opening apparatus 5, and a winding section 6.

Warps 11 pulled out of a creel 7 of the warp supply section 2 are supplied to a weaving section 4 through a heddle 8. On the other hand, wefts 12 pulled out of a bobbin 9 of the weft supply section 3 are inserted between the adjacent warps 11 by a rapier 10 in the weaving section 4 to weave the warps 11 and the wefts 12 into a sheet-shaped woven fabric 13. After the thread-opening apparatus 5 opens and flattens the warps 11 and the wefts 12 of the woven fabric 13, the woven fabric 13 is wound around a cross beam 14.

As shown in FIGS. 1 and 2, the thread-opening apparatus 5 includes a supporting roll 15 guiding the woven fabric 13 to the winding section 6, with the supporting roll 15 supporting the woven fabric 13, a pressing part 17 disposed along a supporting surface 16 of the supporting roll 15, a driving part 18 for reciprocating the pressing part 17 along the direction in which the woven fabric 13 is guided, and a protective sheet supply part 20 for supplying a protective sheet 19 to the gap between the pressing part 17 and the woven fabric 13.

The supporting roll 15 is disposed parallel to the surface of the woven fabric 13. The peripheral surface, namely, the supporting surface 16 of the supporting roll 15 is made of a hard material such as a hard rubber or a metallic material. The supporting roll 15 rotates at a low speed equal to the moving speed of the woven fabric 13.

The pressing part 17 has a plurality of rotatable pressure rolls 21 disposed parallel to the supporting surface 16. Each pressure roll 21 presses the woven fabric 13 supported by the supporting surface 16 toward the supporting surface 16. It is preferable to adjust the degree of the pressing force of the pressure roll 21 to suitably open the threads without adversely affecting the woven fabric 13. Thus each pressure roll 21 is provided with an unshown tool for adjusting the degree of its pressing force and a cushioning member.

As shown in FIG. 3A, the peripheral surface of the pressure roll 21 bulges in its central part like a hand drum. As shown in FIG. 3B, the peripheral surface of the pressure roll 21 is corrugated to cause the up and down movement in the circumferential direction.

The pressure rolls 21 each having a length of less than 20 mm are arranged in series in the width direction of the woven fabric 13 to press the entire woven fabric 13 uniformly. The pressure rolls 21 of adjacent rows shift from each other in the width direction of the woven fabric to allow the woven fabric 13 positioned between the adjacent pressure rolls 21 of each row to be pressed by the pressure roll 21 of the adjacent row.

As shown in FIGS. 1 and 2, the pressing part 17 has a pivoting arm 23 pivoting on a rotation shaft 22 of the supporting roll 15. The driving part 18 for reciprocating the pressing part 17 includes a driving motor 24, a rotary disk 25 to be driven by the driving motor 24, and a connection rod 26. The connection rod 26 interlocks the rotary disk 25 with the pivoting arm 23. Thereby, when the rotary disk 25 rotates, the pivoting arm 23 pivots on the rotation shaft 22 of the supporting roll 15. As a result, the pressure rolls 21 reciprocate along the direction in which the woven fabric 13 is guided.

The protective sheet supply part 20 has a plurality of guide rolls 27 for circulating the protective sheet 19. While the protective sheet 19 is circulating along the periphery of each guide roll 27, the protective sheet 19 is supplied to the gap between the pressure rolls 21 and the woven fabric 13.

### EXAMPLE 2

A woven fabric laminate obtained in the same manner as Example 1 and a polypropylene film (manufactured by Toray Synthetic Film Co., Ltd., thickness 40 μm) were heated and pressurized at 180° C. for 30 minutes at 9.8 MPa to obtain a fiber-reinforced plastic. The resin adhesion amount of polypropylene relative to a total amount of a fiber-reinforced plastic was 15% by mass.

The fiber-reinforced plastic obtained above and alumina ceramic (purity 92%, thickness 5 mm, size 10 cm square; trade name Torayceram manufactured by Toray Industries, Inc.) were adhered with a curing type epoxy adhesive (trade name 1500; manufactured by Cemedine Co., Ltd.) to obtain a hard plate.

### COMPARATIVE EXAMPLE 1

Using the high-performance fiber used in Example 1, a woven fabric (opening rate 0%, cover factor 1953, thread width/thread thickness 4.7) was woven with a rapier weaving machine. The formed plain woven fabric was cut into a size of 30 cm×30 cm, 13 of cut plain woven fabrics were laminated so that the same weight as that of the plain woven fabric of Example 1 was obtained, and a corner part was sewn with a sewing machine to obtain a woven fabric laminate.

The woven fabric laminate obtained above and a polypropylene film (thickness 75 μm), were heated and pressurized at 180° C. for 30 minutes at 9.8 MPa to obtain a fiber-reinforced plastic. A resin adhesion amount of polypropylyne relative to a total amount of a fiber-reinforced plastic was 15% by mass.

The fiber-reinforced plastic obtained above was used to obtain a hard plate as in Example 2.

### EXPERIMENTAL EXAMPLE

The woven fabric laminates obtained in Example 1 and Comparative Example 1, and the fiber-reinforced plastics obtained in Example 2 and Comparative Example 1 were subjected to an impact resistant test with a small caliber shooting apparatus manufactured by Howa Machinery, Ltd., at a rate of about 550 m/s using 1.1 g of a cylindrical steel strip (MIL-spec P46593). In addition, the hard plates of Example 2 and Comparative Example 1 were subjected to an impact resistant test with a test apparatus “HFT-1015” for projectile, manufactured by Sumitomo Coal Mining Co., Ltd., at a rate of 900 m/s using 4.0 g of a projectile (NATO SS-109 false bullet), and penetration and non-penetration were assessed. Regarding woven fabric laminates obtained in Example 1 and Comparative Example 1, and fiber-reinforced plastics obtained in Example 2 and Comparative Example 1, an amount of energy absorption upon collision of a projectile against a woven fabric laminate and a fiber-reinforced plastic was assessed by using the following equation. Results are shown in Table 1.

Amount of energy absorption=½×m×(V1²−V2²) (wherein m denotes a weight (kg) of a projectile, V1 denotes a rate (m/s) before sample collision, and V2 denotes a penetrating rate after sample collision)

TABLE 1

| | Amount of energy | Penetration or |
|---|---|---|
| Tested subject | absorption kg · m | non-penetration |
| Woven fabric laminate obtained | 17 | — |
| in Example 1 | | |
| Fiber-reinforced plastic | 14.1 | — |
| obtained in Example 2 | | |
| Hard plate obtained in | — | Non-penetration |
| Example 2 | | |
| Woven fabric laminate | 15.1 | — |
| obtained in Comparative | | |
| Example 1 | | |
| Fiber-reinforced plastic | 12.3 | — |
| obtained in Comparative | | |
| Example 1 | | |
| Hard plate obtained in | — | Penetration |
| Comparative Example 1 | | |

As can be seen from Table 1, woven fabric laminates, fiber-reinforced plastics and hard plates of Examples exhibited better impact resistance as compared with Comparative Examples.

### INDUSTRIAL APPLICABILITY

According to the present invention, there can be provided a flat woven fabric which has excellent impact resistance to a projectile, and is light, a laminate thereof, a fiber-reinforced plastic using them, or a protection product formed using a composite molded product using them.

1. A protection product characterized in that it is made using a woven fabric woven with a high-performance fiber, wherein the opening rate is 0 to 5% due to thread-opening treatment, and the width of a thread constituting the woven fabric is 10-fold or more relative to the thickness of the thread.

2. A protection product characterized in that it is made using a woven fabric woven with a high-performance fiber, wherein the opening rate is 0 to 2% due to thread-opening treatment, and the width of a thread constituting the woven fabric is 20-fold or more relative to the thickness of the thread.

3. A protection product characterized in that it is made using a woven fabric woven with a high-performance fiber, wherein the cross-sectional shape of a thread constituting the woven fabric is thinner on the edge side of both ends as compared with the intermediate part in the width direction.

4. A protection product characterized in that it is made using a woven fabric woven with a twistless high-performance fiber having a fineness of 200 to 15,000 dtex, wherein the ratio of the thread width to the thread thickness of at least one of a warp and a weft is 10 to 100, and the opening rate is 0 to 5%.

5. A protection product comprising a laminate in which woven fabrics according to claim 4 are laminated and fixed.

6. A protection product comprising a fiber-reinforced plastic containing a woven fabric woven with a twistless high-performance fiber having a fineness of 200 to 15,000 dtex, wherein the ratio of the thread width to the thread thickness of at least one of a warp and a weft is 10 to 100, and the opening rate is 0 to 5%, or a laminate in which the woven fabrics are laminated, a thermosetting resin and/or a thermoplastic resin.

7. A protection product comprising a composite molded product in which a metal or/and a ceramic are laminated on the fiber-reinforced plastic according to claim 6.

8. The protection product according to claim 1, wherein the high-performance fiber is one or more fibers selected from aromatic polyamide, ultra high molecular weight polyethylene, polyparaphenylene benzobisoxazole, polyether ether ketone, polyketone, liquid crystalline polyester, vinylon and polypyridobisimidazole.

9. The protection product according to claim 1, which is a bullet-proof vest.

10. The protection product according to claim 1, which is a helmet.

11. The protection product according to claim 1, which is a hard plate.

12. The protection product according to claim 2, wherein the high-performance fiber is one or more fibers selected from aromatic polyamide, ultra high molecular weight polyethylene, polyparaphenylene benzobisoxazole, polyether ether ketone, polyketone, liquid crystalline polyester, vinylon and polypyridobisimidazole.

13. The protection product according to claim 3, wherein the high-performance fiber is one or more fibers selected from aromatic polyamide, ultra high molecular weight polyethylene, polyparaphenylene benzobisoxazole, polyether ether ketone, polyketone, liquid crystalline polyester, vinylon and polypyridobisimidazole.

14. The protection product according to claim 4, wherein the high-performance fiber is one or more fibers selected from aromatic polyamide, ultra high molecular weight polyethylene, polyparaphenylene benzobisoxazole, polyether ether ketone, polyketone, liquid crystalline polyester, vinylon and polypyridobisimidazole.

15. The protection product according to claim 6, wherein the high-performance fiber is one or more fibers selected from aromatic polyamide, ultra high molecular weight polyethylene, polyparaphenylene benzobisoxazole, polyether ether ketone, polyketone, liquid crystalline polyester, vinylon and polypyridobisimidazole.

16. The protection product according to claim 2, which is a bullet-proof vest.

17. The protection product according to claim 3, which is a bullet-proof vest.

18. The protection product according to claim 4, which is a bullet-proof vest.

19. The protection product according to claim 6, which is a bullet-proof vest.

20. The protection product according to claim 2, which is a helmet.

21. The protection product according to claim 3, which is a helmet.

22. The protection product according to claim 4, which is a helmet.

23. The protection product according to claim 6, which is a helmet.

24. The protection product according to claim 2, which is a hard plate.

25. The protection product according to claim 3, which is a hard plate.

26. The protection product according to claim 4, which is a hard plate.

27. The protection product according to claim 6, which is a hard plate.
